(19) United States
(12) Patent Application Publication
(10) Pub. No.: US 2015/0161832 A1
(43) Pub. Date: Jun. 11, 2015

(54) Method and Apparatus for Virtual Key Delivery

(71) Applicant: Ford Global Technologies, LLC, Dearborn, MI (US)

(72) Inventors: Chad Evert Esselink, Canton, MI (US); David Randolph Roberts, Dearborn, MI (US); Christian Krozal, South Lyon, MI (US); Thomas Woloszyn, Northville, MI (US); Robert Bruce Kleve, Ann Arbor, MI (US); Julius Marchwicki, Detroit, MI (US); David Chase Mitchell, Dearborn, MI (US)

(73) Assignee: Ford Global Technologies, LLC, Dearborn, MI (US)

(21) Appl. No.: 14/097,537

(22) Filed: Dec. 5, 2013

(51) Int. Cl. G07C 9/00

(52) U.S. Cl. CPC G07C 9/00015

(57) ABSTRACT

A system includes a processor configured to receive a request for temporary vehicle usage. The processor is also configured to associate a requesting user with an available vehicle and generate a temporary vehicle access code and start code, usable during a predetermined time period. The processor is further configured to send the access code and start code to both the user and the vehicle.

### TECHNICAL FIELD

The illustrative embodiments generally relate to a method and apparatus for virtual key delivery.

### BACKGROUND

Physical keys to a vehicle provide secure entry and drive access to a vehicle, however they also are inconvenient because they require the user to keep track of and carry them when using a vehicle. Obviously they are even more inconvenient if lost or stolen, they are expensive to replace and can be difficult to transfer to other users. In a fleet environment such as a rental car companies, these inconveniences are multiplied by the fleet size and prove quite costly. Keys induce cost to the company in order to manage, store, locate and replace them. Each vehicle requires a unique physical set of keys which must be stored and then transferred to the renter at the time of rental. They must also be securely stored and then managed age after rental as they are used by crew when cleaning, repairing and transporting vehicles.

For rental car companies without a centralized lot and rental center, such as ZipCar, other difficulties occur. They are forced to provide RFID cards to customers and install expensive aftermarket RFID readers and cellular modems in order to give access to the vehicles for customers. Some of the savings of not having a centralized lot and desk agents is offset by increased equipment costs and modem data plans. Physical keys are stored in the vehicle and then accessed by RFID cards which the reader enables depending on information it received from an aftermarket modem installed inside.

Another common problem is that all existing distributed systems like ZipCar rely on an embedded cellular device and the ability for that module to connect to the cloud to complete authorization. This means that the vehicle must be parked in an area that has cellular coverage in order begin and end any rental. This means additional costs for the fleet owner to purchase or lease parking with cellular or WiFi coverage.

U.S. Application 2002/0186144 generally relates to an automated vehicle rental system for a fleet of rental vehicles, where the vehicles are geographically distributed and normally locked when not rented. At least one of the vehicles, when not in use, is parked in an unguarded location. The system has a vehicle communications unit for enabling communication to and from the vehicle, user-carried electronic devices, or other readers, and for interfacing with the user. An on-board unit (OBU) is located on each of the vehicles for interfacing with the vehicle communications unit, and with a door unlocking mechanism. The system further has a central reservations, management and location system (CRMLS) in communication through a communications network with each OBU, the CRMLS performing all reservations and management functions, and being linked to a database containing a location and availability of each of thr vehicles and a rate for rental, the CRMLS also being provided with an allocation manager system for geographically allocating vehicles. In order to access the vehicle, the system also includes a key being borne by the user. The system minimizes the human intervention in the rental process, and is more user-friendly

U.S. Application 2012/0105197 generally relates to a customer using a wireless portable device to interact with a remote cloud-based car rental service. Details at check in are recorded and the customer is authorized to take possession of the car. At checkout, additional details are noted, a receipt is produced, and the customer leaves the car at the car facility. The check-in and checkout process can be achieved without any car rental attendant. That is, the customer via the wireless portable device and with the assistance of the remote cloud-based car rental service completely achieves check in and checkout for a car rental.

### SUMMARY

In a first illustrative embodiment, a system includes a processor configured to receive a request for temporary vehicle usage. The processor is also configured to associate a requesting user with an available vehicle and generate a temporary vehicle access code and start code, usable during a predetermined time period. The processor is further configured to send the access code and start code to both the user and the vehicle.

In a second illustrative embodiment, a system includes a processor configured to receive input of a temporary access code. The processor is also configured to verify the access code. The processor is further configured to verify that a specified access code enablement time has passed. The processor is additionally configured to enable the access code if the enablement time has passed. The processor is also configured to provide access to the vehicle if the access code is enabled and enable usability of a physical key for vehicle start-up usage if the access code is enabled and access to the vehicle is provided.

In a third illustrative embodiment, a computer-implemented method includes receiving input of a temporary access code. The method also includes verifying the access code and verifying that a specified access code enablement time has passed. The method further includes enabling the access code if the enablement time has passed. Also, the method includes providing access to the vehicle if the access code is enabled and enabling usability of a physical key for vehicle start-up usage if the access code is enabled and access to the vehicle is provided.

### BRIEF DESCRIPTION OF THE DRAWINGS

FIG. 1 shows an illustrative vehicle computing system;

FIG. 2 shows an illustrative example of a wireless key system;

FIG. 3 shows an illustrative example of a wireless key initial setup process;

FIG. 4 shows an illustrative example of a wireless key owner setup process;

FIG. 5 shows an illustrative example of a wireless key delivery process;

FIG. 6 shows an illustrative example of a wireless key usage process;

FIGS. 7A and 7B show illustrative examples of wireless key termination processes;

FIGS. 8A-8D show an illustrative example of a vehicle return process; and

FIGS. 9A-9D show an illustrative example of a vehicle rental process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

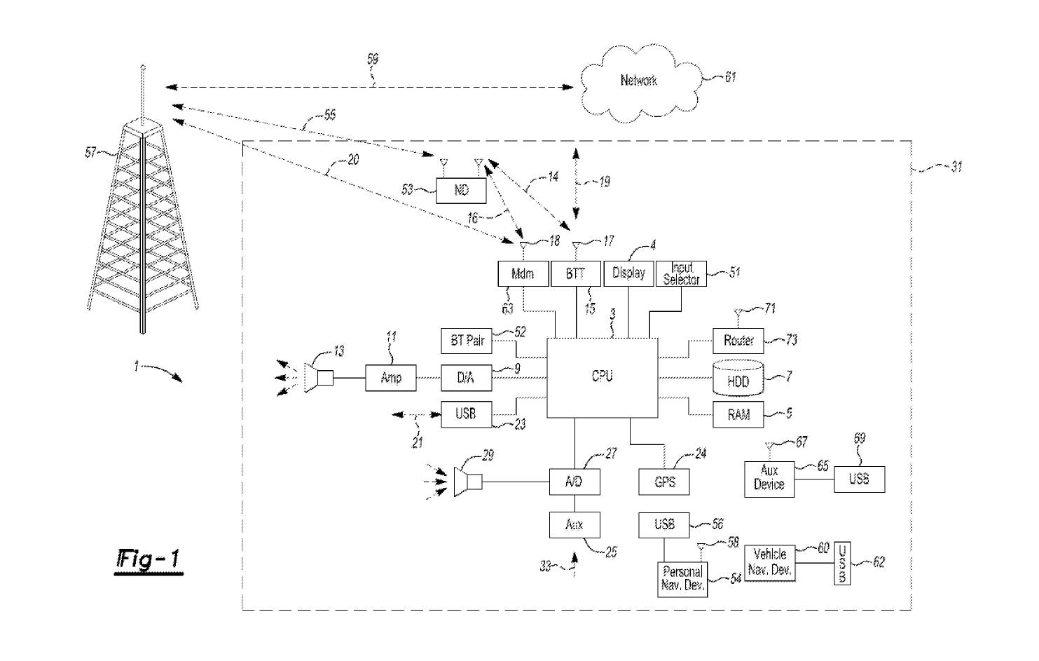

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication. In this example, link 16 may represent NFC communication, or any LAN, can support, for example, WiFi, WiMax and other non-cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

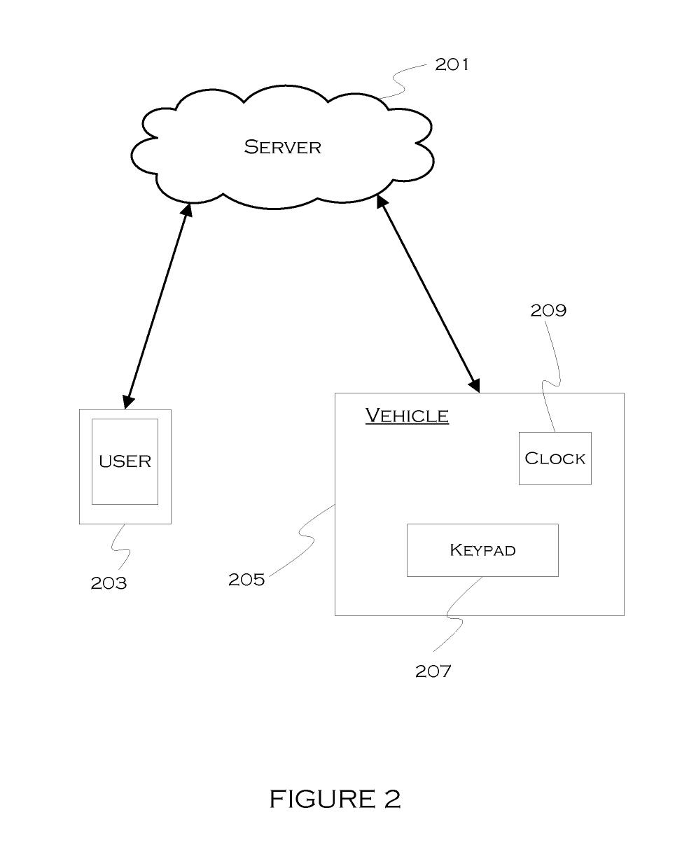

FIG. 2 shows an illustrative example of a wireless key system. The wireless key system provides an alternative to delivering physical keys to a user for use with the vehicle. Additionally, in at least one embodiment, control of physical key usability is enabled, so that keys can be left in, for example, rental vehicles, without fear of the vehicle being stolen through use of the keys.

In this illustrative example, a cloud server 201 is capable of controlling accounts for various vehicles 205. For example, if a fleet had a number of vehicles with the capabilities described herein, the server could associate all those vehicles with a fleet account. The vehicles, in this example, also include a keypad (for vehicle access) and a clock to track vehicle usage and rental start/end times. In some examples the cloud server may be a service provider engaged by the rental owner, or a service provided by the owner, in other examples for smaller fleets, the function of the cloud server may even be performed by the owner's phone.

The accounts can also communicate with any number of users 203. Through an internet connection or app on a phone, the users can access the fleet account to request vehicles. In another embodiment, if someone was borrowing a friend's car, for example, the borrower could access a lender account to request access. Information relating to the use of the vehicle, including access codes and start codes, can be delivered from the cloud server to the user's wireless device 203.

Using the delivered codes, which can be delivered to both the wireless device and the vehicle, for confirmation purposes, the user can access the vehicle through the keypad, and then enable the vehicle using a wireless start code, such as a rolling code.

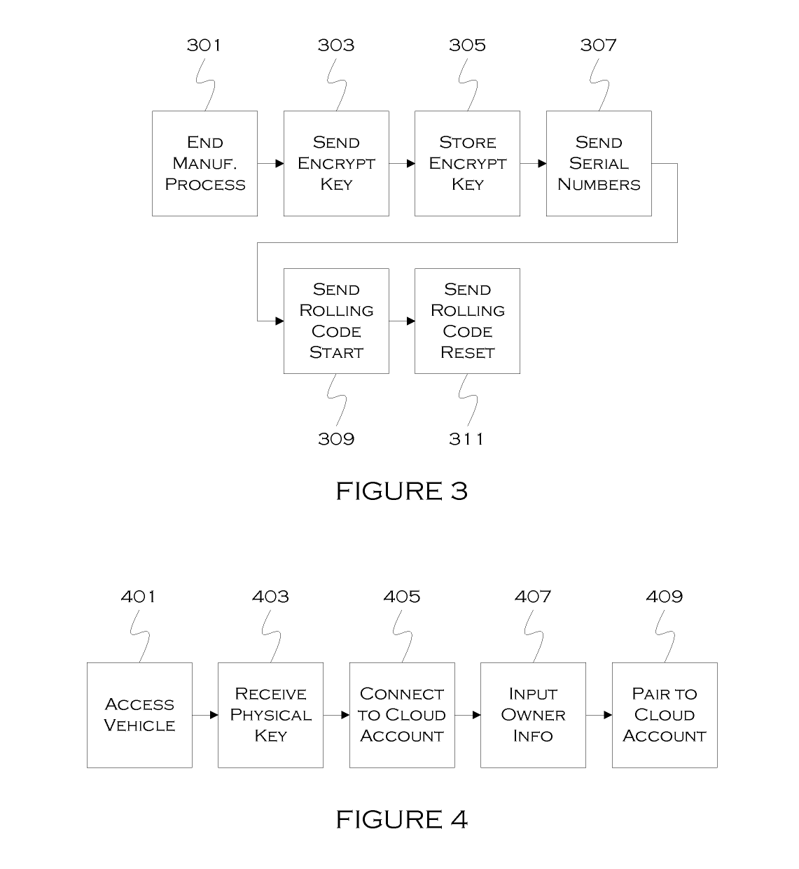

FIG. 3 shows an illustrative example of a wireless key initial setup process. In this illustrative example, a vehicle is initialized during the manufacturing process 301. This occurs before the vehicle is ever sold or owned, and allows an OEM to control setup of the initial vehicle control. This also means that the OEM has the information needed to perform resets and other control functions as needed.

During this process, an encryption key for the vehicle is sent to the OEM server, which handles vehicle accounts, and stored with respect to a remote vehicle account 303. The encryption key is also stored in the vehicle hardware 305. Since both sides then have the key, keyed encryption can be used for communication between the two ends of the system. This is useful when sending keypad codes, temporary user data, rolling ID codes and any other communication between the vehicle and the remote server.

In this illustrative example, several other pieces of information are provided to the cloud server. A vehicle computing system serial number or other identifier can be provided 307. This can be used as a means of secondary authentication in messages, as well as used to identify a receiving system. A rolling code start value 309 and rolling code reset values 311 can also be provided. Rolling codes will change whenever used (or at intervals) so that obtaining a single code value has almost no long-term use, or at least very limited use. This prevents renters from returning to the vehicle and using an old code, and helps prevent theft of a vehicle by theft of a code.

FIG. 4 shows an illustrative example of a wireless key owner setup process. Once the vehicle has been initialized by the manufacturer during manufacture, the vehicle may still have further setup to link the vehicle to a specific owner account. As previously noted, this can be useful for fleet management, and can be additionally useful for an individual who wishes to loan out a car, but doesn't want to leave the keys in the car (encouraging theft).

In this illustrative example, the new owner of the vehicle can access the vehicle 401, using a fixed entry code (the general entry code) or a physical key, or some other designation that represents that this accessing owner is the permanent owner of the vehicle (as opposed to a temporary user). In this example, the process receives entry of the physical key 403, and based on the presence of the key, accesses a cloud based account to be associated with the vehicle 405.

The owner information can then be input, using, for example, a vehicle based HMI. If there is not a sufficient HMI in the vehicle, an application on a mobile device can be used in conjunction with the initialization process, or a website could be used after initialization was started with the physical key. The owner information is input 407 and various identifying vehicle information is shared between the vehicle and the cloud, for example Vehicle Identification Number (VIN, serial numbers of various modules on the vehicle or other unique identifying characteristics. At this point the vehicle is paired with an owner related cloud account. Each vehicle can have an individual account, and/or multiple vehicles can be associated with a single account (for fleet management, for example).

In this manner, any number of fleet vehicles (such as in a rental fleet) can be associated with a user account. Rentals can be processed through the user account, with virtual vehicle keys being delivered to renters for limited access to the specific vehicles.

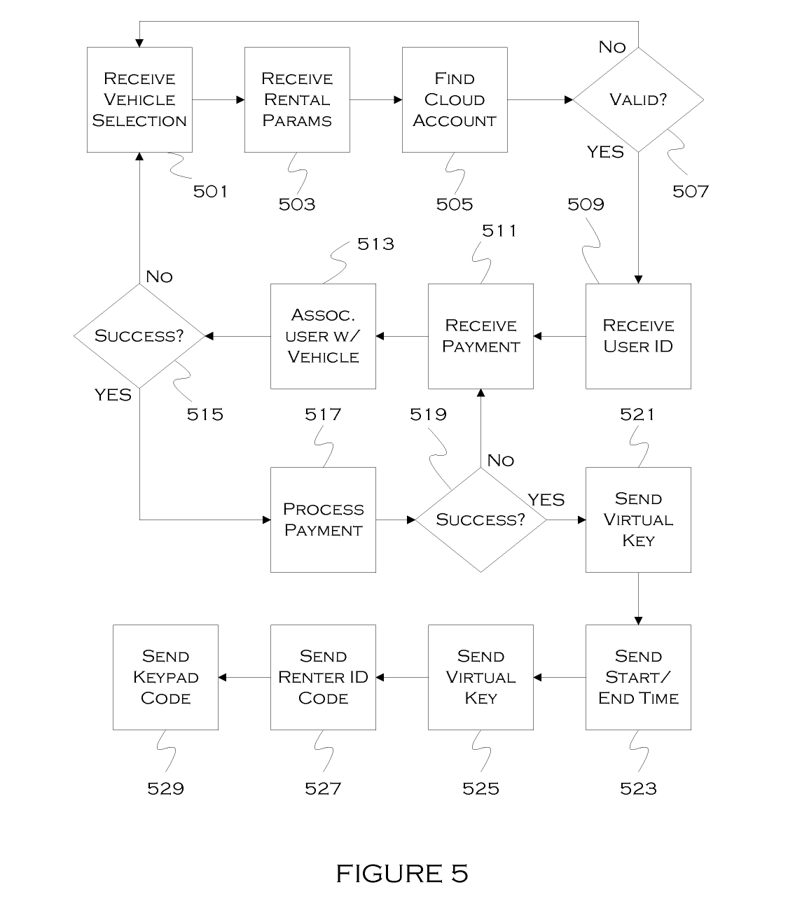

FIG. 5 shows an illustrative example of a wireless key delivery process. In this illustrative example, a user rents a vehicle from a fleet managed with virtual wireless keys. The user can use an application or other interface to process the selection, payment and rental of the vehicle, and then the keys and rental handling can be performed autonomously. This way, vehicles can be located anywhere and a user can still easily access the vehicle. Even if the vehicles are all in a rental lot, however, rental lines can be skipped, and rental personnel can be kept to a minimum. A similar process could be used for borrowing a vehicle, or even for an individual renting their vehicle for temporary use. Thus, this process can facilitate vehicle sharing programs and schema as well.

In this example, a user accesses an inventory of vehicles and selects a specific vehicle or vehicle class 501. If a vehicle class is selected, the process may then select a known vehicle fitting within the vehicle class, for processing the rental. In addition to the vehicle selection, rental parameters (typically date(s) and time(s)) can also be received 503. These parameters can be used when the rental is processed, and also to check vehicle availability.

The process can then access a cloud account 505 having one or more vehicles associated therewith. For example, without limitation, the rental company may have a cloud account with all of the vehicles owned by that company. Using the cloud account, the process can check if the selected vehicle is available that fits the rental parameters.

Since virtual key handling can be controlled through the cloud account, the cloud account can also act as a scheduler, since it knows when a virtual key for a given vehicle will expire. While some grace period may be built into the rental period, the process can generally know when a given vehicle will be available. Also, since a number of vehicles may be accessible through the same account, the process can check for other vehicles if a given vehicle is not available at the specified time (i.e., the renter arrives and the vehicle has not yet been returned). Dynamic reassignment of vehicles can be easily facilitated through the application. Also, if a user wants to change vehicle class, the system can easily disable the old virtual key and send a new virtual key for a different vehicle.

Once a vehicle selection has been verified as available, the process may receive a user identification 509. This may include, among other things, an identifier as to where a virtual key is to be sent. This can include, but is not limited to, an email address, phone number, text number, application ID, etc. The process can also receive payment for the rental, if payment is due in advance 511. Payment receipt can also be delayed, if desired, until some moment before the virtual key is delivered (allowing for cancellations, etc.).

The process, once any needed information has been received, can then associate the user with the vehicle 513. This can include saving a rental date for the user, and setting the vehicle as “rented” during the specified time. Virtual keys for the rental period can also be setup at this time. If the association is successful 515, and virtual keys can be established, the process can proceed to receive the payment from the specified source 517 (if desired).

If the payment was successful 519, the process can send the information for the virtual key, even if the rental period is days, weeks or months away 521. This is possible because the virtual key has a temporally related start and end date. This means that the key will not function outside the specified time period (with certain exceptions), and is generally useless until the rental period arrives. While the key may be non-functional, the user may still be happy to receive the key in advance.

The system may allow renters to change the rental dates, and to facilitate this and to prevent misuse or fraud in situations without Cellular or Wifi connectivity, the system may use an incrementing Renter Number and Event or Command Number that is included in the encrypted packet and the vehicle system then only accepts a Renter Number or Command Number that is higher than before. In this way the system can make changes to a renter's virtual key by sending a new one to the renter's phone with a higher Renter Number. If the reservation is for a date farther in the future, the Renter number sent to the user may be much higher to allow for other renters to reserve the car in the timer period before then future rental start. The command number may also be incremented upon each connection to the vehicle to increase the security. The key may also include a refreshing of the next valid entry codes for the vehicle to store for future renters so as to keep the vehicle with a supply of valid entry codes.

Also, since the key is virtual, if the reservation is cancelled or changed, the process can simply disable the key, so that the key never functions at all. This may be done by forcing the renter to cancel or change the reservation by connecting his phone to the cloud account so that virtual key stored on the renters phone may be overwritten by a terminated key or a changed key. In this example, the key consists of a key code to enter the vehicle, and a rolling code to activate the vehicle. By disabling one or both of these keys, the user will be prevented from using the vehicle on the specified times. Outside of those times, the key will generally be designated as non-functional.

The start and end times can be sent to the vehicle as well 523, along with a copy of the virtual key 525. The vehicle can then store the key and the enablement times, and, when the time approaches, the vehicle can enable the key. Thus, if the vehicle is out of communication range with the remote server for some reason, the user is not prevented from entering and using the vehicle.

In conjunction with this information, a vehicle entry code 527 and a vehicle start code 529 can both be sent to the vehicle and the user. Both can be temporary codes, both enabled for finite periods of time. This prevents early or late use of the codes, stopping the user from accessing the vehicle outside the rental parameters. The entry code can be used to access the vehicle interior, through a doorpad, for example, and the start code could be entered in the vehicle (on an HMI or other device) to enable the vehicle to start. Limited power can be provided to the HMI when a valid door code is used, for the purpose of entering the secondary code. Codes using various vehicle buttons can also be used (a series of radio button presses, for example) in systems without sufficient HMIs.

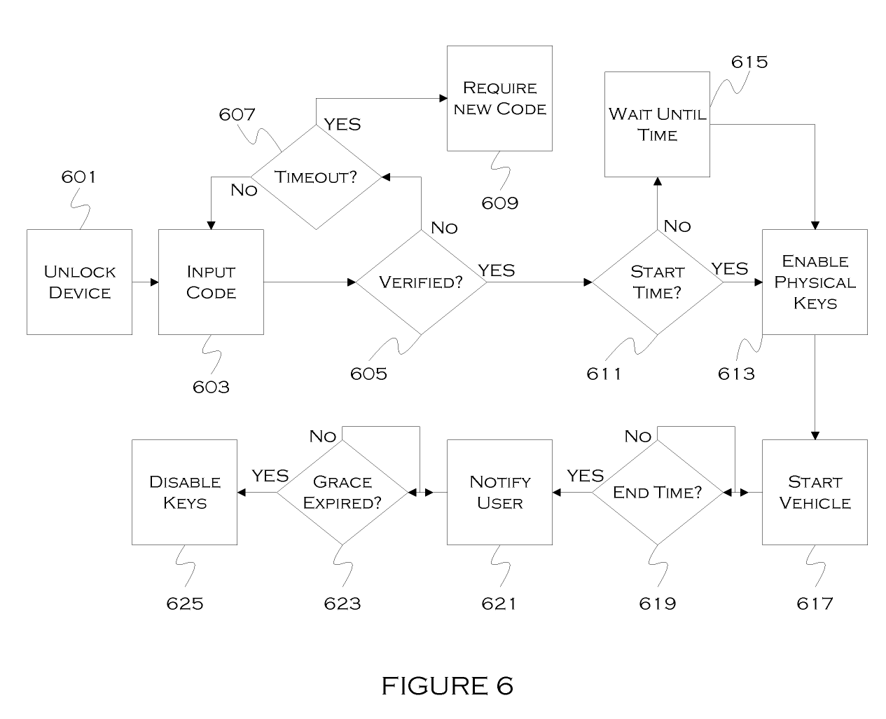

FIG. 6 shows an illustrative example of a wireless key usage process. This is an exemplary process for access and use of the vehicle utilizing a virtual key. While a “standard” key may also be used in conjunction with this embodiment, the virtual key is used to access the vehicle during the rental period initially, and for vehicle startup in the absence of the physical key. The virtual key consists of two codes, in this embodiment, an access code for the vehicle and a startup code, and thus serves the same functions as a physical key would.

In this illustrative embodiment, the user uses the virtual key code to unlock the vehicle 601. In this example, the code is entered on the vehicle door, on a keypad, but other suitable methods of entry may also be used (wireless access through a connection to the phone, for example). Biometric ID could also be used, if the user scanned in a fingerprint on rental and the vehicle was equipped with biometric sensors. The same is true for the code to start the vehicle. In fact, in the biometric case, the rental company could be assured that the renting user was the person accessing the vehicle.

Once the code has been input into the door, and the vehicle is unlocked, the user enters a second code into the vehicle in order to start the vehicle 603. This is the renter ID code, and corresponds to a rolling code enabled for the rental period. In this example, the renter ID code can be used in place of a physical key, but the physical key can also be used.

If the code is not verified 605, the process checks to see if a timeout has occurred 607. Timeout, in this sense, includes exceeding a number of code entry attempts. If the timeout occurs, then the system assumes that someone is attempting to invalidly access the vehicle, and a new code can be requested 609 and sent to the user. If the person attempting to access the vehicle is anyone other than the authorized user, they presumably will not receive the new code, and thus will still not be able to start the vehicle.

Once the correct code has been entered, the process can check to see if the code is within its valid time period 611. Since the code is valid only after a particular start time, the user may not be able to use the code to access the vehicle until the start time arrives. In such a case, the process will wait until the start time has passed 615 before allowing the vehicle to activate.

In another example, if the user is a few hours early, but no one else is scheduled to use the vehicle in the intervening time period, the process may enable the code early. Since the process is aware of the code, it can validate the code as authentic, and then apply a new start time based on the fact that no one else needs to use the vehicle. New start time information can be recorded for billing purposes if desired.

In some instances, physical keys may be left in the vehicle as well. These keys can correspond to literal keys, or radio frequency (RF) keys that enable a push button start. In either event, these keys may be disabled unless a valid unlock and/or rolling ID code has been entered. In this example, both codes are entered before the physical key is enabled 613, but in other instances, only one code may be needed to enable the physical keys. For example, the user could enter a temporarily usable door code, during a valid time period, and have the physical keys immediately enabled.

Also, in this example, the vehicle is started 617. This can assist a user who can't find the keys. Or, if the previous user inadvertently left with the physical keys, the rolling code can still be used to start the vehicle, so the user isn't without access to the vehicle.

The rolling code and or physical keys continue to work for the vehicle until a rental end time arrives 619. The end time signifies the end of the rental contract, and the time at which the vehicle is to be returned or parked for use by another user.

Once the end time arrives, the process may notify the user 621, so the user knows that the next time the vehicle is turned off, the keys will cease to work. Exceptions to this policy can, of course, be made. For example, in this embodiment, a grace period will continue to run 623, presumably allowing the user to get the vehicle to a designated location. In other instances, a single stop at a location corresponding to a fuel station may be allowed, so the user can fill up the tank. Once the grace period expires, if desired, both the physical and virtual keys can be disabled. This will not necessarily shut down the vehicle, it just prevents the vehicle from being restarted (unless automatic shutdown is desired).

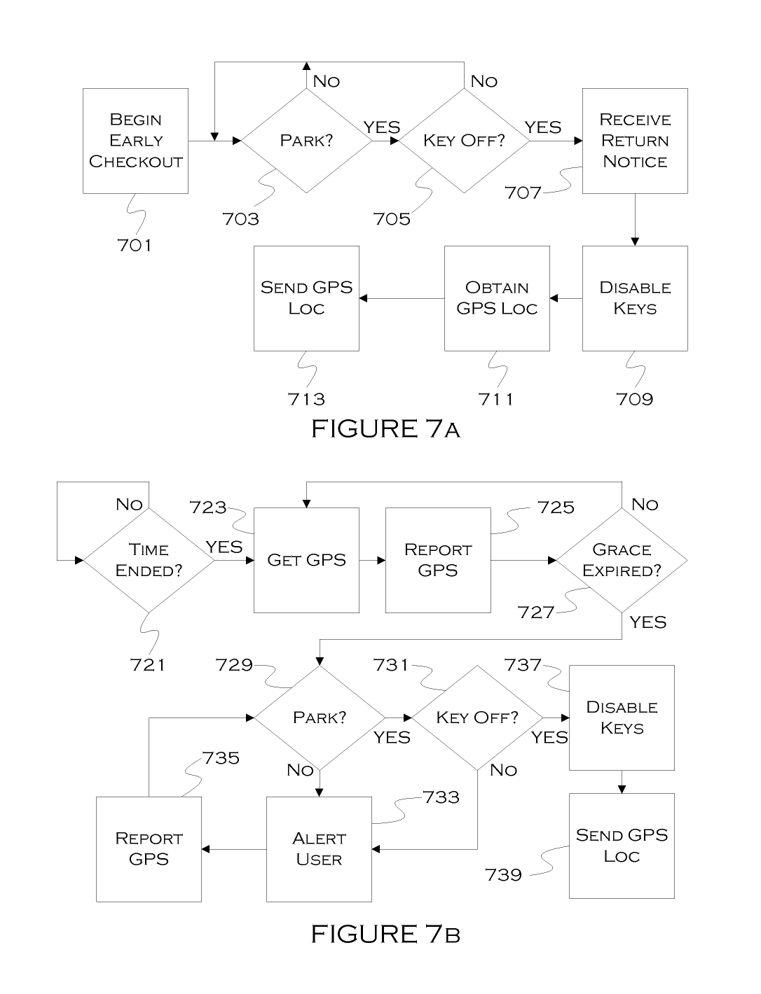

FIGS. 7A and 7B show illustrative examples of wireless key termination processes.

FIG. 7A shows an example of a “standard” return process. In this illustrative embodiment, the renter returns the car, as agreed upon, within the requisite period of time. The renter may use an app or a vehicle interface, for example, to initiate a check-out process for returning the vehicle 701.

In order to ensure that safety is maintained, the process may check to see if the vehicle is in park 703 and off 705 before the checkout begins. This also helps prevent the user from using the vehicle after the checkout process has completed (preventing checkout, for example, when the user is still miles from a destination, but has run out of agreed upon time). In addition this provides a measure of theft protection while the vehicle is parked between rental periods Once the checkout process is completed, the vehicle key will be disabled, as will the virtual key. The door key may also be disabled, or may remain active for some period of time, in case the user leaves an item in the vehicle. After a suitable time period, the door key may also be disabled.

Once the vehicle has been parked and powered off, the process receives a return notice from the remote server, verifying the return 707. At this point, the keys can be disabled 709 and the user can be notified that the vehicle can no longer be used.

Also, at this point, the process can take a GPS location of the vehicle (or a phone, running an app) to locate where the vehicle has been left 711. This could be particularly useful in the case where the vehicle is not left in a rental lot or other known location. The GPS location is then sent to the account owner 713, so the account owner can locate the vehicle. This location could also be sent to the next renter, so that renter can also locate the vehicle.

FIG. 7B shows an illustrative example of a rental end period where the renter does not reach an intended destination by the time the rental period expires. In this illustrative embodiment, the renter is either traveling in the vehicle, or has the vehicle located at a point where the vehicle was not intended to be left. In the latter case, if desired, the vehicle keys can simply be disabled, or the grace period can still be provided. In another embodiment, the renter could be warned and a limited time table could be set for returning the vehicle to a specified locale.

In this illustrative example, the process obtains and reports a vehicle GPS position 723, 725. This can be used to augment the grace period 727, if desired, for example, by extending the grace period if the vehicle is close to, or traveling towards, an intended destination. As long as the grace period continues 727, the process continues to report the vehicle GPS location. The grace period could also be prematurely ended if the vehicle strayed too far from a geographic region (such as a route headed to, or generally headed to, an intended destination).

Once the grace period has ended, the process checks to see if the vehicle is in a park state 729. If the vehicle is in park, the process can also check to see if the ignition is in an off state 731. If the park state and off state are not both present, the process can alert the user that a grace period has expired 733 and request that the user proceed to vehicle return as quickly as possible. The user may also be notified, for example, that the keys will soon be disabled. Actual conditions for key disabling may be provided or not, as desired. The GPS location of the vehicle can also be reported 735 for tracking purposes.

Once the vehicle is in park, and the key has been turned off (ignition off), the process can proceed to disable the keys 737. This can include, as above, some or all of the virtual key elements and/or the physical key. The process can also send the GPS location of the vehicle 739 to the rental company for tracking, retrieval and next renter use.

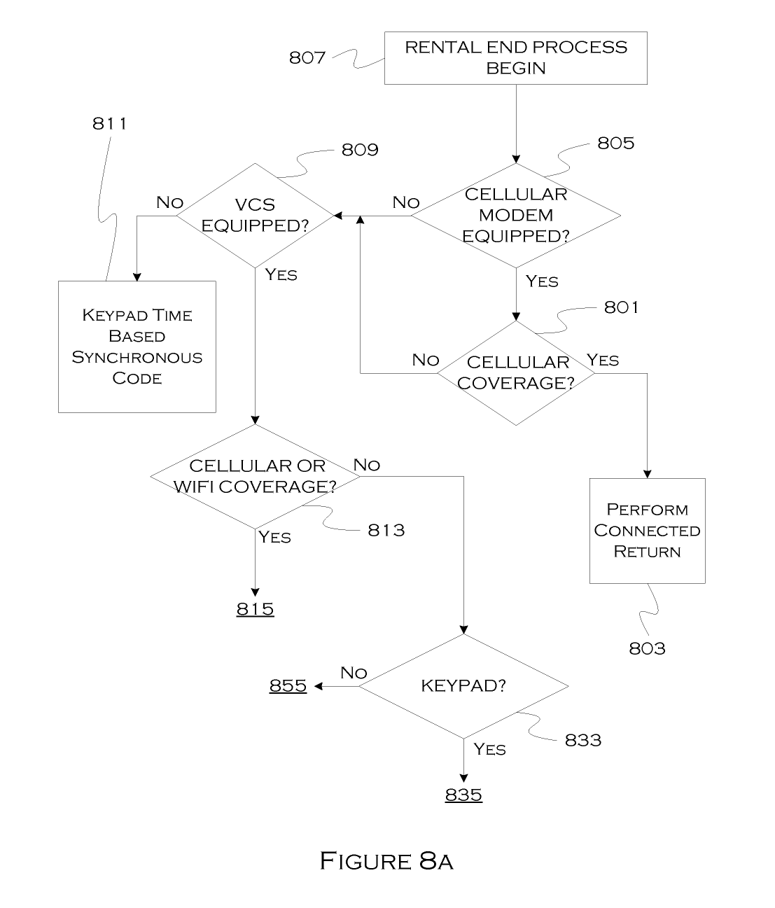

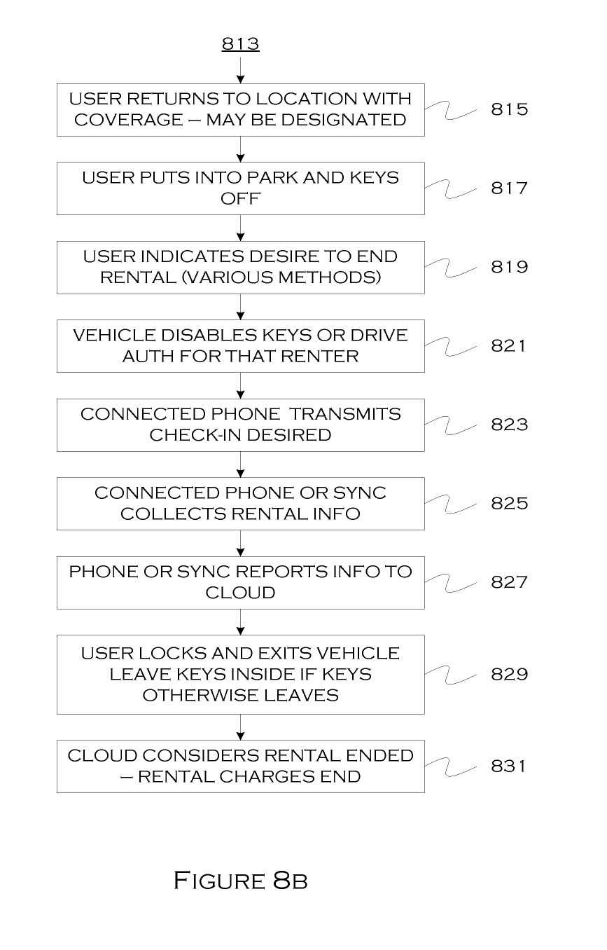

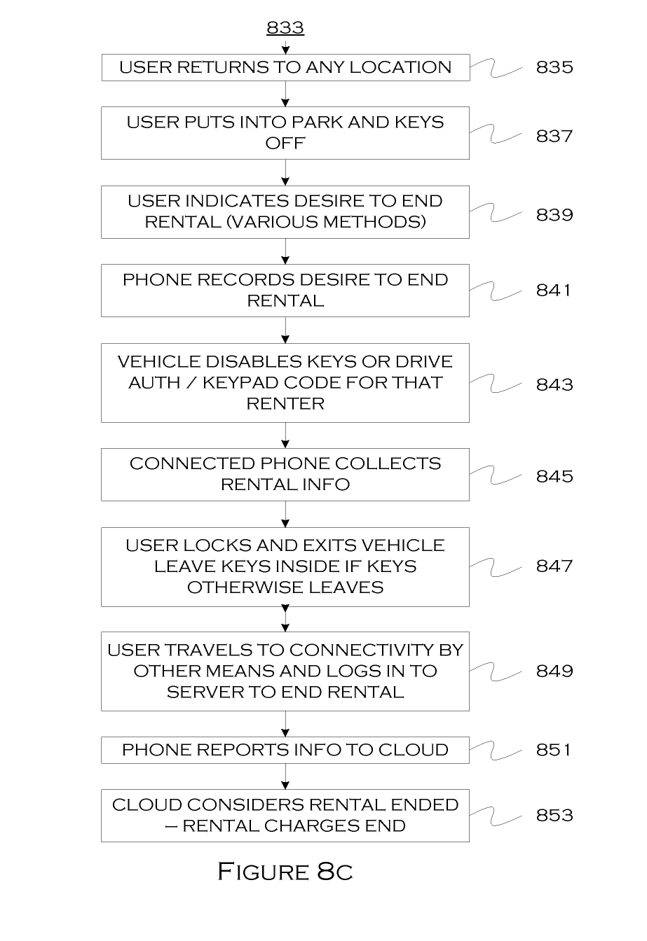

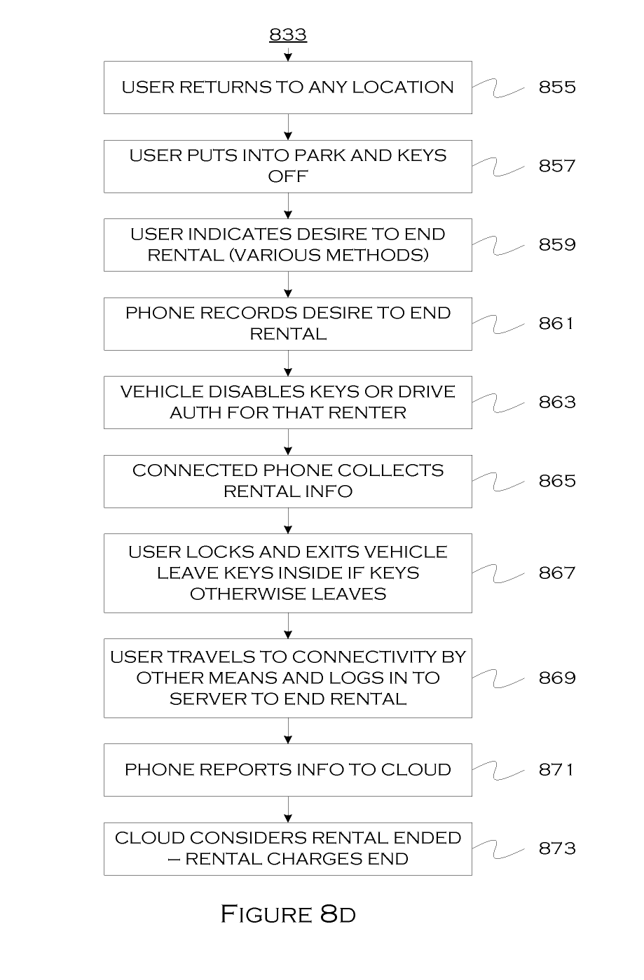

FIGS. 8A-8D show an illustrative example of a vehicle return process. In this illustrative example, the user decides to begin a rental end process 807. The process checks to see if a cellular modem is provided with the vehicle 805. If a cellular modem is provided, and if cellular coverage exists 801, the process will perform a return process for a connected vehicle 803, such as that shown in FIG. 7A, for example. Since the vehicle is connected to the cloud via a vehicle-based modem, check-out and return handling is made easy by direct communication between the vehicle and the cloud. Any temporary keys can be disabled, PINS can be disabled and/or reset, and a vehicle location can be logged via the cloud for a next renter.

This is a common scenario, for example, in a rental return lot. Since the provider will know that the lot has sufficient coverage to provide a connection to the vehicle (or coverage could be provided by a LAN), the rental company will be able to generally ensure that the transaction can be handled seamlessly on their lot. The remainder of the Figures in 8A-8D deals with the cases where connectivity to a vehicle-installed modem is not available.

If there is no cellular modem, or if the cellular coverage does not currently exist for the modem to be connected, the process may have to take additional steps when a return is requested. For example, the rental end may not be allowed to occur until the user places the vehicle into park and keys off so that the vehicle may not be moved after the rental is considered ended. If there is a vehicle infotainment system 809, the process checks to see if cellular or WiFi coverage is available for that system to connect to the cloud 813. If there is no infotainment system, then the process will typically work off of a rolling code. The system can expire the current rolling code 811, and create a new rolling code when the next user arrives.

If the system has both an infotainment or telematics system and connectivity available 815 (i.e., the user has returned to an area with coverage, possibly a designated area), the user will put the vehicle in park and power off the ignition 817. The user then (if this has not already been done) indicates that the rental process should end 819. The vehicle system may use a variety of methods to receive the renter's intention to end the rental. As a non-limiting example, the user may enter his intention into vehicle HMI or a phone APP, or by placing a smart key into a LF backup pocket. A rental time may have passed, triggering the end process, or the user could, for example, manually initiate rental end.

The process then disables the keys and/or drive authorization for that user 821. This can be done, for example, by disabling a remote key, invalidating a code, or through any other means of deactivating whatever activation process was used to engage the vehicle.

In this example, the telematics system is connected to the cloud through a wireless phone, wirelessly connected to the vehicle system. The process transmits check-in/return notification through the connected phone 823. This can be done using the phone as a pass-through, or through an actual application running on the phone and communicating with both the vehicle and the cloud.

The process also, at this point, collects rental information 825, which can include, but is not limited to, total time of rental, location of vehicle, vehicle mileage and any other trip parameters the rental company wishes to gather. For example, any diagnostic warnings (low fuel, low tire pressure, etc.) could be sent, so the company knows the vehicle needs to be serviced before re-rental. A current fuel level could also be gathered and sent, if the renter is obligated to return the vehicle with a certain level of fuel. This information is then reported back to the cloud 827, for use by the rental company in various capacities.

Once the check-out procedure is complete, the user locks the vehicle and exits the vehicle, leaving the keys (if present) inside 829. Also, the vehicle could automatically lock after some brief time period once the user has exited, to ensure the vehicle is locked if in a remote location. The vehicle may also perform final key search and confirm that the key is left inside the vehicle for keys with that capability and report this information to the server. At this point, the rental ends and any charges can be processed 831.

If there is no cellular or WiFi (or other connectivity) available, the process may engage a vehicle key-pad if present 833. If there is a keypad on the vehicle, the vehicle can be returned to any location 835. Since the vehicle will not connect with the cloud upon rental-end, in this example, the user can return the vehicle to any location, whether or not coverage is present.

Again, the user will place the vehicle in park and key-off 837, then indicate that rental ending is desired 839. In this example, since there is no current connection to the cloud, a mobile device (e.g., a phone) will record the rental end process for later transmission 841. Since the vehicle still has functionality in the absence of connection, it will disable any appropriate keys as previously discussed 843.

In this example, the phone and/or vehicle will gather rental return information for later reporting 845. In some cases, the phone may gather the information for later reporting. In other examples, a vehicle computer may gather the information to be transmitted the next time the vehicle has connectivity. The user then locks the vehicle, leaving the keys inside if needed 847.

At some point, the phone or vehicle (depending on which source gathered the rental-end information) will re-enter a zone of connectivity and will be connected to the cloud 849. At this point, the gathered information can be reported 851. The rental will end, in this example, at either the vehicle recorded return time or the reporting time, depending on which scenario is desired by the vehicle owner and described by the rental agreement 853.

Even if a keypad is not present, there are possibilities for a user to return the vehicle to any location. If the user returns the vehicle to a location without coverage, in a telematics-equipped, no-keypad vehicle, after stopping the vehicle 855 and parking and powering down 857, the user can indicate a desire to end the rental 859.

Once again, the phone, or a vehicle telematics unit (or other suitable computer) can record the relevant rental end information 861 (such as end-time). The vehicle can disable all keys 863 and the vehicle or phone can collect all the additional information needed relating to the rental 865.

The user can then lock exit the vehicle. Here again, the vehicle may automatically lock after some brief time period once the user has exited, to ensure the vehicle is locked. The vehicle may also report to the user's phone that keys were left inside, a valid lock was performed and the vehicle is secured at the time of the renters departure. The user must then travel to an area with cellular or wifi connectivity and connect his phone to report the ending rental conditions. At this point, the rental ends and any charges can be processed 831. The user may be credited for traveling time to connectivity at this point as well depending on the rental agreement terms. Again, if the vehicle did the recording, the reporting will be delayed until the vehicle re-enters connectivity (through a connected phone, for example). Once connectivity is re-established, the process will report the relevant information 871 and the rental process will end 873.

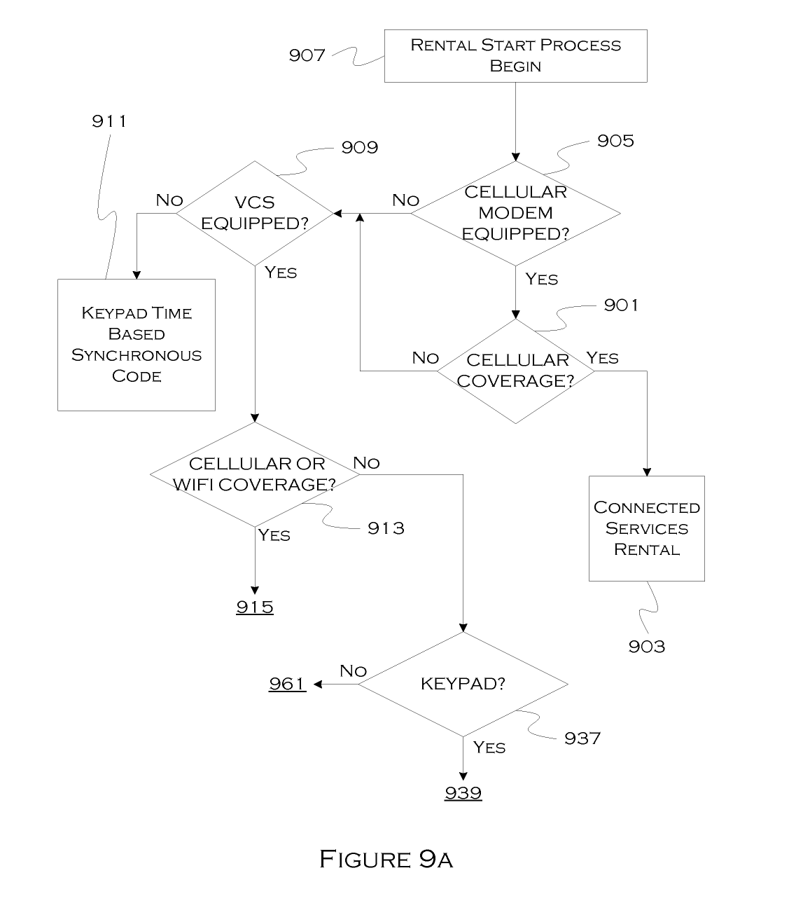

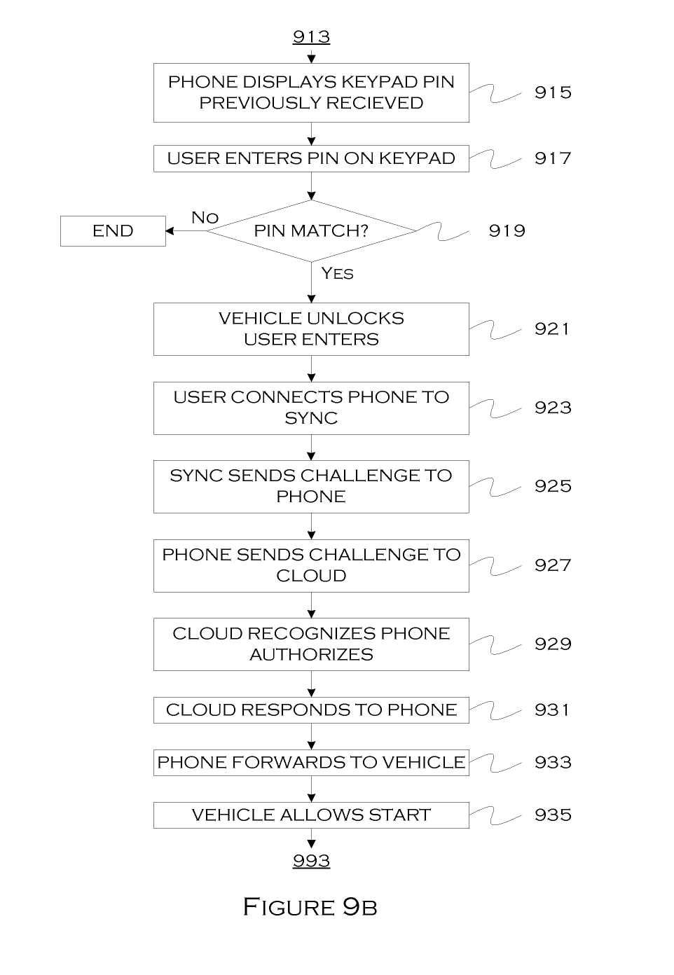

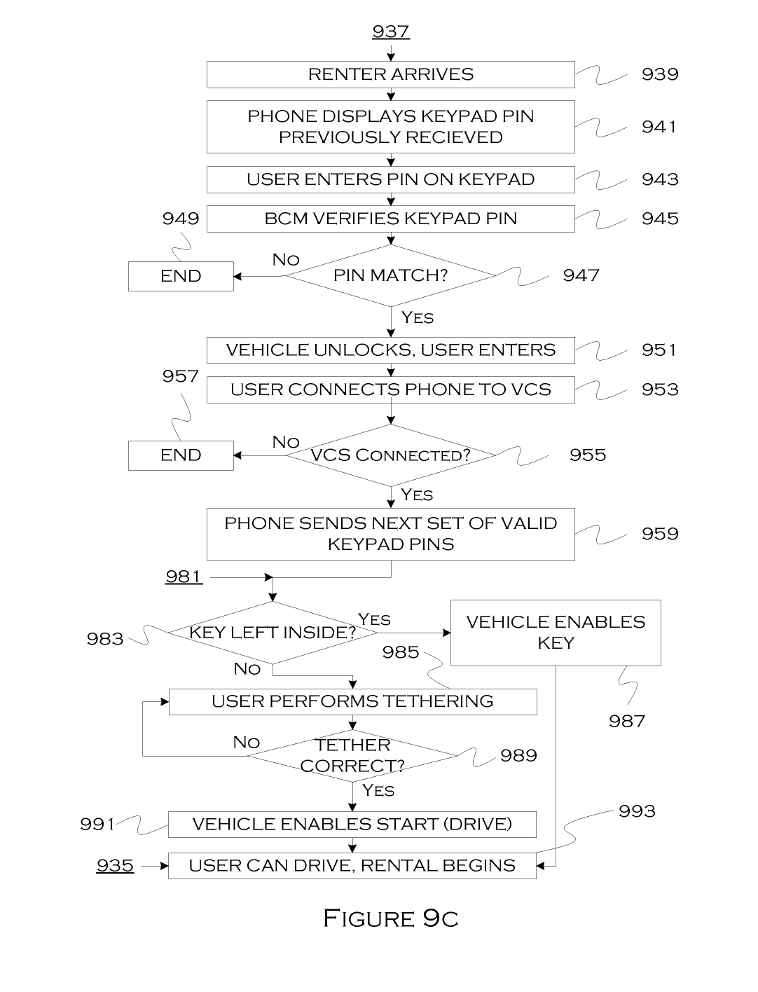

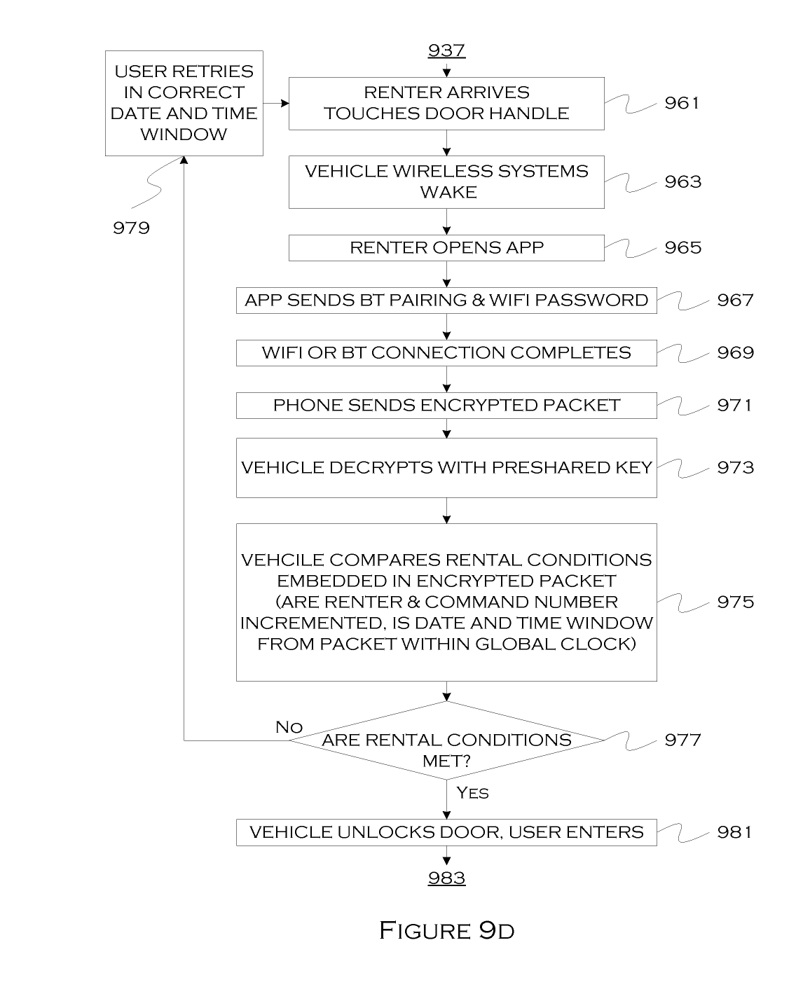

FIGS. 9A-9D show an illustrative example of a vehicle rental process. In this illustrative example, the user may rent a vehicle that has the following possible features: 1) in-vehicle modem (present/not present), in-vehicle telematics/infotainment computer (present/not present), access/startup keypad(s) (present/not present). This is just an illustrative example of vehicle choices, and the invention is not necessarily limited to vehicles having these options.

In this example, the process 907 checks to see if the vehicle is equipped with a modem 905. If there is a modem, and coverage exists 901, the process will use the connected vehicle computer in communication with the cloud to initiate the rental 903. Keys can be generated and activated, as well as codes transferred to a vehicle. Any and all enabling can be done on the spot, since the vehicle is connected and in communication with the cloud. Appropriate rental parameters (expirations, geofences, etc.) can also be set.

If there is no cellular coverage, or if there is no embedded modem present, the process checks for a telematics unit or infotainment system with connectivity options 909. If there is no such telematics unit, the process may utilize a rolling code for vehicle start 911. Rolling codes transform at a known interval into a known new code, so that two unconnected sources can generate the same next code and each source can recognize the validity/expiration of a given code based on the rolling code algorithm.

If there is cellular coverage for the telematics unit the process will instruct a phone to display a pin for input into a vehicle keypad (access keypad) 915. The user enters the pin 917 and the process checks for a match 919. In this example, the vehicle has also been provided with a copy of the pin, so that validity can be ensured. Entry of a correct pin unlocks the vehicle 921.

The user connects a phone to the telematics unit 923, which, in this example, uses a pre-approved phone to authorize vehicle start. The vehicle sends a challenge to the phone 925, which sends the challenge to the cloud 927.

Since the user, in this example, used a known phone to setup the rental and receive the entry pin, the cloud can recognize the phone 929 and authorize the phone. The cloud responds with the authorization 931, which is forwarded to the vehicle 933 and the vehicle can start 935.

If there is no cellular or WiFi coverage, the phone cannot be used to verify vehicle start, since the cloud is unavailable. In this example, the initial entry process is the same, the renter arrives 939, obtains a pin 941 (which was previously received, when coverage was available) and enters the pin 943 for verification 945.

If the pin matches a pin saved on the vehicle at a previous point (when coverage was available, during setup by the owner, initial manufacture or based on a rolling code, if rolling codes are used), the process unlocks the vehicle 951.

Since local connections can still be made, the phone can connect to the telematics unit 953. Once the phone is connected 955, the phone will securely send a set of key codes to the vehicle 959. These codes were initially received by the phone when the access code was received, previously stored by the vehicle and can be used to start the vehicle.

If a physical key is present in the vehicle 983, the vehicle can, upon receiving the valid code(s), enable the key 987.

If there is no key inside, the user can perform a tethering process 985, which, if correct, can enable vehicle start 989. The vehicle can then be started 991 and the rental can begin 993.

If there is no connectivity to the cloud, and no keypad for pin entry, the process can utilize BLUETOOTH or other recognition to allow vehicle access. When the renter arrives at the vehicle and touches the handle 961, the wireless system wakes up 963.

The renter will then open an application on the wireless device (e.g., phone) and the application will send BLUETOOTH pairing and a WiFi password to the vehicle 967 This will allow connection and pairing of the phone with the locked vehicle 969. Another non-limiting example of connection method that may be used here is NFC (Near Field Communication) or other similar short range wireless protocol.

Once a connection (local) is established, the process will send an encrypted packet 971, received when the rental was requested at a time when the phone had connectivity to the cloud. This packet will be decrypted by the vehicle 973. The packet may contain identifying information such as the Vehicle Identification Number (VIN) or serial number of various modules connected to the VCS. This information is specific to the target vehicle and will have been shared with the rental owner in the setup process. The packet can also contain various rental information usable to determine if access should be permitted. This can include, but is not limited to, renter number, date, time, command number or entry-event number, rental start and end time etc.

If the conditions for rental are met 977, the process can unlock the vehicle and allow entry 981. At this point, the process can enable startup as in the exterior keypad example shown in FIG. 9C.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request for temporary vehicle usage;
associate a requesting user with an available vehicle;
generate a temporary vehicle access code and start code, usable during a predetermined time period; and
send the access code and start code to both the user and the vehicle.

2. The system of claim 1, wherein the user is a vehicle renter.

3. The system of claim 2, wherein the processor is further configured to access a cloud-based account associated with a rental agency and select the available vehicle from a pool of vehicles associated with the rental agency in the cloud-based account.

4. The system of claim 3, wherein the processor accesses a stored rolling code associated with the available vehicle, and stored in the cloud-based account, to generate the temporary vehicle start code.

5. A system comprising:
a processor configured to:
receive input of a temporary access code;
verify the access code;
verify that a specified access code enablement time has passed;
enable the access code if the enablement time has passed;
provide access to the vehicle if the access code is enabled; and
enable usability of a physical key for vehicle start-up usage if the access code is enabled and access to the vehicle is provided.

6. The system of claim 5, wherein the processor is further configured to verify that a specified access code disablement time has not passed.

7. The system of claim 6, wherein, if the disablement time has passed, the processor disables the access code.

8. The system of claim 7, wherein, if the disablement time has passed, the processor disables usability of the physical key.

9. The system of claim 8, wherein the processor only disables usability of the physical key if the vehicle is in park and the ignition is off.

10. The system of claim 8, wherein the processor only disables usability of the physical key if a grace period has passed following the disablement time.

11. The system of claim 5, wherein the processor is further configured to:
receive a vehicle startup code;
verify the startup code;
verify that a startup code enablement time has passed;
enable the startup code if the startup code enablement time has passed; and
provide vehicle startup upon code entry if the startup code is enabled.

12. The system of claim 11, wherein the startup code enablement time and the access code enablement time are the same time.

13. A computer-implemented method comprising:
receiving input of a temporary access code;
verifying the access code;
verifying that a specified access code enablement time has passed;
enabling the access code if the enablement time has passed;
providing access to the vehicle if the access code is enabled; and
enabling usability of a physical key for vehicle start-up usage if the access code is enabled and access to the vehicle is provided.

14. The method of claim 13, further comprising verifying that a specified access code disablement time has not passed.

15. The method of claim 14, further comprising disabling the access code if the disablement time has passed.

16. The method of claim 15, further comprising disabling usability of the physical key, if the disablement time has passed.

17. The method of claim 16, wherein the physical key usability is only disabled if the vehicle is in park and the ignition is off.

18. The method of claim 16, wherein the physical key usability is only disabled if a grace period has passed following the disablement time.

19. The method of claim 13, further comprising:
receiving a vehicle startup code;
verifying the startup code;
verifying that a startup code enablement time has passed;
enabling the startup code if the startup code enablement time has passed; and
providing vehicle startup upon code entry if the startup code is enabled.

20. The system of claim 19, wherein the startup code enablement time and the access code enablement time are the same time.
